(19) United States
(12) Patent Application Publication
(10) Pub. No.: US 2019/0181989 A1
(43) Pub. Date: Jun. 13, 2019

(54) Method for Transmitting HARQ Acknowledgement Information and Device

(71) Applicant: Huawei Technologies Co., Ltd., Shenzhen (CN)

(72) Inventors: Xiaocui Li, Beijing (CN); Kai Xu, Shenzhen (CN); Lili Zhang, Beijing (CN)

(21) Appl. No.: 16/323,098

(22) PCT Filed: Aug. 3, 2016
(86) PCT No.: PCT/CN2016/093120

§ 371 Date: Feb. 4, 2019

(51) Int. Cl. H04L 1/18; H04L 5/00; H04W 72/02; H04W 72/04; H04W 16/14

(52) U.S. Cl. CPC H04L 1/1819; H04L 5/0055; H04W 72/02; H04W 16/14; H04W 72/0446; H04W 72/0453; H04W 72/042

(57) ABSTRACT

A method for transmitting hybrid automatic repeat request (HARQ) acknowledgement information and a device to provide a manner of performing HARQ feedback in a Licensed Assisted Access-Long Term Evolution (LAA-LTE) system. The method for transmitting HARQ acknowledgement information includes sending, by a network device, first information to user equipment, where the first information indicates a subframe to be used by the user equipment to send the HARQ acknowledgement information to the network device on an unlicensed carrier, and receiving, by the network device in the subframe indicated by the first information, the HARQ acknowledgement information from the user equipment.

### TECHNICAL FIELD

The present invention relates to the field of mobile communications technologies, and in particular, to a method for transmitting HARQ acknowledgement information and a device.

### BACKGROUND

In a downlink hybrid automatic repeat request (Hybrid Automatic Repeat-request, HARQ) in frequency division duplex (Frequency Division Duple, FDD), a base station sends downlink data to user equipment (User Equipment, UE) in a subframe n. After receiving the downlink data, the UE sends HARQ acknowledgement information to the base station in a subframe n+4. If the HARQ acknowledgement information sent by the UE is a negative acknowledgement (NACK), the base station may re-transmit the downlink data to the UE in a subframe n+8.

In a downlink HARQ in time division duplex (Time Division Duple. TDD), a base station sends downlink data to UE in a subframe n. After receiving the data, the UE may send, based on different uplink/downlink configurations (ULDL configuration) shown in Table 1, HARQ acknowledgement information to the base station in a subframe n+k.

TABLE 1

| Uplink/ | | | | | | | | | | |
|---|---|---|---|---|---|---|---|---|---|---|
| downlink | | | | | | | | | | |
| config- | Subframe (n) | | | | | | | | | |
| uration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, | — | — | — | — | 8, 7, | — | — |
| | | | 4, 6 | | | | | 4, 6 | | |
| 3 | — | — | 7, 6, 11 | 6, 5 | 5, 4 | — | — | — | — | — |
| 4 | — | — | 12, 8, | 6, 5, | — | — | — | — | — | — |
| | | | 7, 11 | 4, 7 | | | | | | |
| 5 | — | — | 13, 12, 9, | — | — | — | — | — | — | — |
| | | | 8, 7, 5, | | | | | | | |
| | | | 4, 11, 6 | | | | | | | |
| 6 | — | — | 7 | 7 | 5 | — | — | 7 | 7 | — |

However, for a licensed-assisted access using Long Term Evolution (Licensed-Assisted Access Using Long Term Evolution, LAA-LTE) system, because time division multiplexing (Time Division Multiplexing, TDM) is used for uplink/downlink transmission in LAA-LTE, and there is no fixed uplinkidownlink configuration, if a HARQ feedback solution in FDD is used in the LAA-LTE system, the subframe N+4 is probably not an uplink subframe, and corresponding HARQ acknowledgement information cannot be sent. In addition, because there is no fixed uplink/downlink configuration in the LAA-LTE system, a HARQ feedback solution in TDD cannot be used either. Therefore, in the LAA-LTE system, there is currently no solution for performing HARQ feedback on an unlicensed carrier.

### SUMMARY

Embodiments of the present invention provide a method for transmitting HARQ acknowledgement information and a device, to provide a manner of performing HARQ feedback in an LAA-LTE system.

According to a first aspect, a method for transmitting HARQ acknowledgement information is provided. The method includes: sending, by a network device, first information to user equipment, where the first information is information used to indicate a subframe used by the user equipment to send HARQ acknowledgement information to the network device on an unlicensed carrier; and receiving, by the network device in the subframe indicated by the first information, the HARQ acknowledgement information sent by the user equipment.

In the embodiments of the present invention, an uplink subframe is known to the network device, and therefore the network device may send the first information to the user equipment. The first information indicates a subframe that can be used by the user equipment to send the HARQ acknowledgement information to the network device. After receiving the first information, the user equipment may send the HARQ acknowledgement information to the network device based on the first information, that is, perform HARQ feedback. To be specific, the embodiments of the present invention provide a manner of performing HARQ feedback, by using which the HARQ feedback can be desirably performed.

With reference to the first aspect, in a first possible implementation of the first aspect, the first information is used to indicate a single subframe, and the first information includes a subframe index or a subframe index offset of the indicated single subframe. The subframe index offset is used to indicate an offset of the subframe index of the single subframe relative to a subframe index of a subframe in which the network device sends downlink data to the user equipment, and the downlink data is downlink data corresponding to the HARQ acknowledgement information.

In this case, the first information may indicate the single subframe. Such a manner is relatively simple, and the user equipment can easily figure out, based on the first information, a subframe indicated by the network device, to directly send the HARQ acknowledgement information to the network device in the subframe. Because a quantity of subframes indicated by the first information is relatively small, it may be considered that a data amount of the first information is also relatively small, thereby saving transmission resources. In addition, for the user equipment, workload of parsing the first information is relatively light, and device load is relatively light.

With reference to the first aspect, in a second possible implementation of the first aspect, the first information is used to indicate a subframe window, and the first information includes at least one of: subframe indexes of a plurality of subframes in the subframe window indicated by the network device, a subframe index of a start subframe and a subframe index of an end subframe in the subframe window, and a subframe index of a start subframe in the subframe window and subframe span information. The subframe span information is used to indicate a quantity of the subframes indicated by the first information.

In this case, the first information may indicate a plurality of subframes. When sending the HARQ acknowledgement information to the network device in the subframe indicated by the first information, the user equipment first needs to preempt a channel, and the channel may fail to be preempted. If the first information indicates a plurality of subframes, after failing to preempt the channel once, the user equipment may further preempt a channel in another subframe indicated by the first information, thereby improving a success rate of sending the HARQ acknowledgement information by the user equipment.

With reference to the second possible implementation of the first aspect, in a third possible implementation of the first aspect, if the first information includes the subframe indexes of the plurality of subframes, the plurality of subframes are consecutive subframes or non-consecutive subframes.

To be specific, subframes indicated by the first information may be consecutive subframes or non-consecutive subframes, provided that the subframes are uplink subframes. This is not limited in the embodiments of the present invention.

With reference to any one of the first aspect or the first possible implementation to the third possible implementation of the first aspect, in a fourth possible implementation of the first aspect, the first information is carried in downlink control information of a physical downlink control channel.

The downlink control information may be used to schedule downlink data. The first information may be directly carried in the downlink control information, so that the network device does not need to additionally and specially send the first information. This manner is relatively simple and can reduce an interaction process between devices.

With reference to any one of the first aspect or the first possible implementation to the fourth possible implementation of the first aspect, in a fifth possible implementation of the first aspect, after the receiving, by the network device in the subframe indicated by the first information, the HARQ acknowledgement information sent by the user equipment: if failing to receive the HARQ acknowledgement information in the subframe indicated by the first information, receiving, by the network device, a notification message sent by the user equipment, where the notification message is used to instruct the network device to receive the HARQ acknowledgement information on another unlicensed carrier or receive the HARQ acknowledgement information on a licensed carrier.

When sending the HARQ acknowledgement information to the network device in the subframe indicated by the first information, the user equipment first needs to preempt a channel, and the channel may fail to be preempted. If the user equipment fails to preempt a channel in each subframe indicated by the first information, the user equipment may send the HARQ acknowledgement information to the network device on another unlicensed carrier or a licensed carrier, to ensure that the HARQ acknowledgement information can be normally sent. Because the network device needs to receive the HARQ acknowledgement information at a correct location, if the user equipment needs to send the HARQ acknowledgement information to the network device on another unlicensed carrier or a licensed carrier, the user equipment may notify the network device by sending a notification message to the network device, so that the network device can correctly receive the HARQ acknowledgement information, and the network device is prevented from failing to receive the HARQ acknowledgement information.

With reference to any one of the first aspect or the first possible implementation to the fourth possible implementation of the first aspect, in a fifth possible implementation of the first aspect, after the receiving, by the network device in the subframe indicated by the first information, the HARQ acknowledgement information sent by the user equipment: if failing to receive the HARQ acknowledgement information in the subframe indicated by the first information, sending, by the network device, a notification message to the user equipment, where the notification message is used to instruct the user equipment to send the HARQ acknowledgement information on another unlicensed carrier or send the HARQ acknowledgement information on a licensed carrier.

If the user equipment fails to preempt a channel in each subframe indicated by the first information, the user equipment cannot send the HARQ acknowledgement information to the network device, and the network device can determine that the HARQ acknowledgement information fails to be received. In this case, the network device may send a notification message to the user equipment, to instruct the user equipment to send the HARQ acknowledgement information to the network device on another unlicensed carrier or a licensed carrier, to ensure that the HARQ acknowledgement information is normally sent. In addition, the network device may know about each carrier well, and therefore the network device indicates a specific carrier on which the user equipment continues to send the HARQ acknowledgement information. The user equipment sends the HARQ acknowledgement information based on the indication of the network device, and a success rate of sending the HARQ acknowledgement information is improved.

According to a second aspect, a method for transmitting HARQ acknowledgement information is provided. The method includes: receiving, by user equipment, first information sent by a network device, where the first information is information used to indicate a subframe used by the user equipment to send HARQ acknowledgement information to the network device on an unlicensed carrier; and sending, by the user equipment, the HARQ acknowledgement information to the network device in the subframe indicated by the first information.

Because an uplink subframe is known to the network device, the network device may send the first information to the user equipment. The first information indicates a subframe that can be used by the user equipment to send the HARQ acknowledgement information to the network device, and the user equipment may send, based on the first information, the HARQ acknowledgement information to the network device after receiving the first information, that is, perform a HARQ feedback, thereby improving a success rate of sending the HARQ acknowledgement information.

With reference to the second aspect, in a first possible implementation of the second aspect, the first information is used to indicate a single subframe, and the first information includes a subframe index or a subframe index offset of the indicated single subframe. The subframe index offset is used to indicate an offset of the subframe index of the single subframe relative to a subframe index of a subframe in which the network device sends downlink data to the user equipment, and the downlink data is downlink data corresponding to the HARQ acknowledgement information.

With reference to the second aspect, in a second possible implementation of the second aspect, the first information is used to indicate a subframe window, and the first information includes at least one of: subframe indexes of a plurality of subframes in the subframe window indicated by the network device, a subframe index of a start subframe and a subframe index of an end subframe in the subframe window, and a subframe index of a start subframe in the subframe window and subframe span information. The subframe span information is used to indicate a quantity of the subframes indicated by the first information.

With reference to the second possible implementation of the second aspect, in a third possible implementation of the second aspect, if the first information includes the subframe indexes of the plurality of subframes, the plurality of subframes are consecutive subframes or non-consecutive subframes.

With reference to any one of the second aspect or the first possible implementation to the third possible implementation of the second aspect, in a fourth possible implementation of the second aspect, the first information is carried in downlink control information of a physical downlink control channel.

With reference to any one of the second aspect or the first possible implementation to the fourth possible implementation of the second aspect, in a fifth possible implementation of the second aspect, after receiving the first information sent by the network device, the user equipment preempts a channel on the unlicensed carrier. In this case, the user equipment may send, in the following manner, the HARQ acknowledgement information to the network device in the subframe indicated by the first information: if the user equipment successfully preempts a channel on the unlicensed carrier, sending, by the user equipment, the HARQ acknowledgement information to the network device in the subframe indicated by the first information.

When sending the HARQ acknowledgement information to the network device in the subframe indicated by the first information, the user equipment first needs to preempt a channel. If the channel is successfully preempted, the user equipment may normally send the HARQ acknowledgement information to the network device in the subframe indicated by the first information, and the network device may normally receive the HARQ acknowledgement information based on the first information.

With reference to the fifth possible implementation of the second aspect, in a sixth possible implementation of the second aspect, the method may further include: if the user equipment fails to preempt a channel on the unlicensed carrier, sending, by the user equipment, the HARQ acknowledgement information to the network device on another unlicensed carrier; or if the user equipment fails to preempt a channel on the unlicensed carrier, sending, by the user equipment, the HARQ acknowledgement information to the network device on a licensed carrier.

If the user equipment fails to preempt a channel in the subframe indicated by the first information, to ensure that the HARQ acknowledgement information can be sent to the network device, the user equipment may send the HARQ acknowledgement information to the network device on another unlicensed carrier or a licensed carrier. This manner is relatively flexible, and prevents a transmission failure of the HARQ acknowledgement information.

According to a third aspect, a network device is provided. The network device may include a transmitter and a receiver. The transmitter is configured to send first information to user equipment, where the first information is information used to indicate a subframe used by the user equipment to send HARQ acknowledgement information to the network device on an unlicensed carrier. The receiver is configured to receive, in the subframe indicated by the first information, the HARQ acknowledgement information sent by the user equipment.

With reference to the third aspect, in a first possible implementation of the third aspect, the first information is used to indicate a single subframe, and the first information includes a subframe index or a subframe index offset of the indicated single subframe. The subframe index offset is used to indicate an offset of the subframe index of the single subframe relative to a subframe index of a subframe in which the network device sends downlink data to the user equipment, and the downlink data is downlink data corresponding to the HARQ acknowledgement information.

With reference to the third aspect, in a second possible implementation of the third aspect, the first information is used to indicate a subframe window, and the first information includes at least one of: subframe indexes of a plurality of subframes in the subframe window indicated by the network device, a subframe index of a start subframe and a subframe index of an end subframe in the subframe window, and a subframe index of a start subframe in the subframe window and subframe span information. The subframe span information is used to indicate a quantity of the subframes indicated by the first information.

With reference to the second possible implementation of the third aspect, in a third possible implementation of the third aspect, if the first information includes the subframe indexes of the plurality of subframes, the plurality of subframes are consecutive subframes or non-consecutive subframes.

With reference to any one of the third aspect or the first possible implementation to the third possible implementation of the third aspect, in a fourth possible implementation of the third aspect, the first information is carried in downlink control information of a physical downlink control channel.

With reference to any one of the third aspect or the first possible implementation to the fourth possible implementation of the third aspect, in a fifth possible implementation of the third aspect, the receiver is further configured to: if failing to receive the HARQ acknowledgement information in the subframe indicated by the first information, receive a notification message sent by the user equipment. The notification message is used to instruct the network device to receive the HARQ acknowledgement information on another unlicensed carrier or receive the HARQ acknowledgement information on a licensed carrier.

With reference to any one of the third aspect or the first possible implementation to the fourth possible implementation of the third aspect, in a sixth possible implementation of the third aspect, the transmitter is further configured to: if the receiver fails to receive the HARQ acknowledgement information in the subframe indicated by the first information, send a notification message to the user equipment. The notification message is used to instruct the user equipment to send the HARQ acknowledgement information on another unlicensed carrier or send the HARQ acknowledgement information on a licensed carrier.

According to a fourth aspect, user equipment is provided. The user equipment may include a receiver and a transmitter. The receiver is configured to receive first information sent by a network device, where the first information is information used to indicate a subframe used by the user equipment to send HARQ acknowledgement information to the network device on an unlicensed carrier. The transmitter is configured to send the HARQ acknowledgement information the network device in the subframe indicated by the first information.

With reference to the fourth aspect, in a first possible implementation of the fourth aspect, the first information is used to indicate a single subframe, and the first information includes a subframe index or a subframe index offset of the indicated single subframe. The subframe index offset is used to indicate an offset of the subframe index of the single subframe relative to a subframe index of a subframe in which the network device sends downlink data to the user equipment, and the downlink data is downlink data corresponding to the HARQ acknowledgement information.

With reference to the fourth aspect, in a second possible implementation of the fourth aspect, the first information is used to indicate a subframe window, and the first information includes at least one of: subframe indexes of a plurality of subframes in the subframe window indicated by the network device, a subframe index of a start subframe and a subframe index of an end subframe in the subframe window, and a subframe index of a start subframe in the subframe window and subframe span information. The subframe span information is used to indicate a quantity of the subframes indicated by the first information.

With reference to the second possible implementation of the fourth aspect, in a third possible implementation of the fourth aspect, if the first information includes the subframe indexes of the plurality of subframes, the plurality of subframes are consecutive subframes or non-consecutive subframes.

With reference to any one of the fourth aspect or the first possible implementation to the third possible implementation of the fourth aspect, in a fourth possible implementation of the fourth aspect, the first information is carried in downlink control information of a physical downlink control channel.

With reference to any one of the fourth aspect or the first possible implementation to the fourth possible implementation of the fourth aspect, in a fifth possible implementation of the fourth aspect, the user equipment further includes a processor. The processor is configured to preempt a channel on the unlicensed carrier. The transmitter is configured to: if a channel on the unlicensed carrier is successfully preempted, send the HARQ acknowledgement information to the network device in the subframe indicated by the first information.

With reference to the fifth possible implementation of the fourth aspect, in a sixth possible implementation of the fourth aspect, the transmitter is further configured to: if the user equipment fails to preempt a channel on the unlicensed carrier, send the HARQ acknowledgement information to the network device on another unlicensed carrier; or if the user equipment fails to preempt a channel on the unlicensed carrier, send the HARQ acknowledgement information to the network device on a licensed carrier.

According to a fifth aspect, another network device is provided. The network device may include a functional unit configured to perform the method according to the first aspect or any possible implementation of the first aspect.

According to a sixth aspect, another user equipment is provided. The user equipment may include a functional unit configured to perform the method according to the second aspect or any possible implementation of the second aspect.

According to a seventh aspect, an embodiment of the present invention provides a computer storage medium, configured to store a computer software instruction used by the foregoing network device, and the computer software instruction includes a program designed for the network device to perform the foregoing aspects.

According to an eighth aspect, an embodiment of the present invention provides a computer storage medium, configured to store a computer software instruction used by the foregoing user equipment, and the computer software instruction includes a program designed for the user equipment to perform the foregoing aspects.

In the embodiments of the present invention, the network device indicates a subframe in which the user equipment sends the HARQ acknowledgement information, and the user equipment does not need to select a subframe on its own, thereby minimizing a possibility that the HARQ acknowledgement information fails to be sent because a subframe selected by the user equipment may not be an uplink subframe, and improving a success rate of sending the HARQ acknowledgement information.

### BRIEF DESCRIPTION OF DRAWINGS

To describe the technical solutions in the embodiments of the present invention more clearly, the following briefly describes the accompanying drawings required for describing the embodiments of the present invention.

FIG. 1 is a schematic diagram of an application scenario according to an embodiment of the present invention;

FIG. 2 is a flowchart of a method for transmitting HARQ acknowledgement information according to an embodiment of the present invention;

FIG. 3 is a schematic diagram of sending HARQ acknowledgement information by user equipment according to an embodiment of the present invention:

FIG. 4 is a schematic diagram of sending HARQ acknowledgement information by user equipment according to an embodiment of the present invention;

FIG. 5 is a schematic structural diagram of a network device according to an embodiment of the present invention;

FIG. 6 is a schematic structural diagram of user equipment according to an embodiment of the present invention;

FIG. 7 is a schematic structural diagram of a network device according to an embodiment of the present invention; and

FIG. 8 is a schematic structural diagram of user equipment according to an embodiment of the present invention.

### DESCRIPTION OF EMBODIMENTS

To make the objectives, technical solutions, and advantages of the embodiments of the present invention clearer, the following clearly describes the technical solutions in the embodiments of the present invention with reference to the accompanying drawings in the embodiments of the present invention. Apparently, the described embodiments are some but not all of the embodiments of the present invention.

In the following, some terms in the present invention are described, to help persons skilled in the art have a better understanding.

(1) User equipment is a device that provides a user with voice and/or data connectivity, and for example, may include a handheld device having a wireless connection function or a processing device connected to a wireless modem. The user equipment may communicate with a core network by using a radio access network (Radio Access Network, RAN), and exchange voice and/or data with the RAN. The user equipment may include UE, a wireless terminal device, a mobile terminal device, a subscriber unit (Subscriber Unit), a subscriber station (Subscriber Station), a mobile station (Mobile Station), a mobile console (Mobile Console), a remote station (Remote Station), an access point (Access Point, AP), a remote terminal (Remote Terminal), an access terminal (Access Terminal), a user terminal (User Terminal), a user agent (User Agent), a user device (User Device), or the like. For example, the user equipment may be a mobile phone (or referred to as a “cellular” phone), a computer having a mobile terminal, a portable mobile apparatus, a pocket-sized mobile apparatus, a handheld mobile apparatus, a computer built-in mobile apparatus or an in-vehicle mobile apparatus. For example, the user equipment may be a device such as a personal communications service (Personal Communication Service, PCS) phone, a cordless telephone set, a Session Initiation Protocol (SIP) phone, a wireless local loop (Wireless Local Loop, WLL) station, or a personal digital assistant (Personal Digital Assistant, PDA).

(2) A network device is, for example, a base station (for example, an access point), and may be specifically a device that communicates with a wireless terminal device over an air interface by using one or more sectors in an access network. The base station may be configured to perform conversion between a received over-the-air frame and an IP packet, and is used as a router between the wireless terminal device and the rest of the access network. The rest of the access network may include an Internet Protocol (IP) network. The base station may further coordinate attribute management of the air interface. For example, the base station may be an evolved base station (a NodeB or an eNB or an e-NodeB, evolved NodeB) in a system such as a Long Term Evolution (Long Term Evolution, LTE) system or an LTE-Advanced (LTE-Advanced, LTE-A) system. This is not limited in the embodiments of the present invention.

(3) An LAA-LTE system is a system in which an LTE technology is used in an unlicensed carrier, and a licensed carrier is used as a primary cell (PCell) and the unlicensed carrier is used as a secondary cell (SCell) based on a carrier aggregation architecture. In addition, to ensure that the LAA technology can coexist with another technology used in the unlicensed carrier, a channel contention access mechanism of listen before talk (Listen-Before-Talk, LBT) is used in the LAA-LTE system, that is, both the user equipment and the network device need to preempt a channel first before sending data on the unlicensed carrier, and can send the data only when the channel is successfully preempted.

(4) A physical downlink control channel is used to transmit control information, and may be, for example, a physical downlink control channel (Physical Downlink Control Channel, PDCCH), or may be another physical downlink control channel, or the PDCCH may have another name. This is not limited in the embodiments of the present invention.

(5) The terms “system” and “network” may be used interchangeably in the embodiments of the present invention. “A plurality of” means two or more than two. The term “and/or” describes an association relationship for describing associated objects and represents that three relationships may exist. For example, A and/or B may represent the following three cases: Only A exists, both A and B exist, and only B exists. In addition, the character “/” generally indicates an “or” relationship between the associated objects unless specified otherwise.

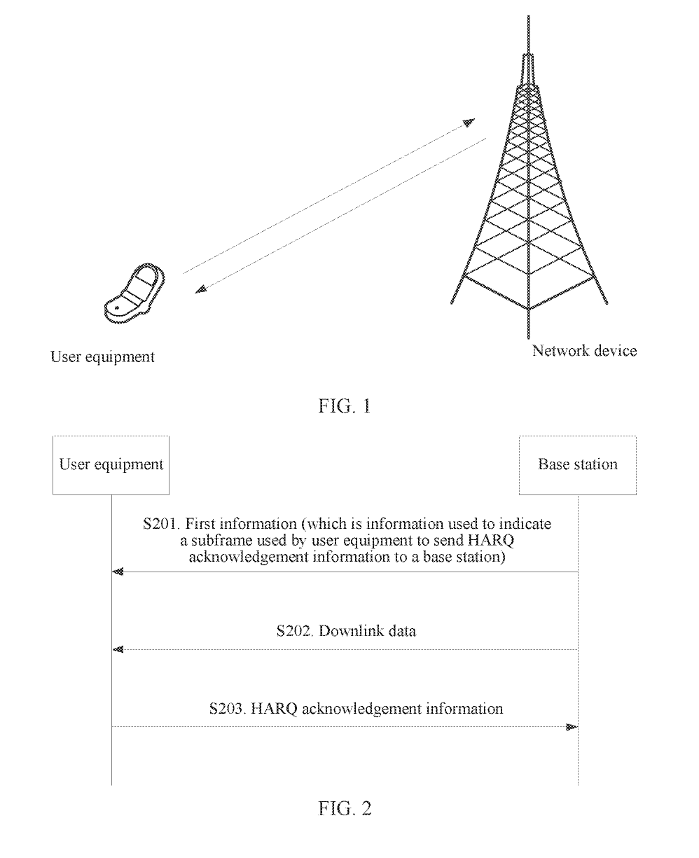

An application scenario of an embodiment of the present invention is described first. FIG. 1 includes user equipment and a network device. The user equipment and the network device may communicate with each other. After the network device sends downlink data to the user equipment, the user equipment returns HARQ acknowledgement information to the network device depending on whether the downlink data is successfully received. The HARQ acknowledgement information includes an acknowledgement (ACK) and a NACK. If the user equipment successfully receives the downlink data sent by the network device, the user equipment may return an ACK to the network device, and the network device may continue to transmit new data or end the transmission process. However, if the user equipment fails to receive the downlink data sent by the network device, the user equipment may return a NACK to the network device, and the network device may re-transmit the data that is transmitted last time, to maximize a success rate of data transmission.

However, in the LAA-LTE system, there is no fixed uplink/downlink configuration, and therefore a subframe that is selected by the user equipment and in which the user equipment sends the HARQ acknowledgement information to the network device is probably not an uplink subframe, leading to a transmission failure of the HARQ acknowledgement information. In view of this, an embodiment of the present invention provides a new method for transmitting HARQ acknowledgement information. It should be known that, the method provided in this embodiment of the present invention may be applied to an LAA-LTE system, and in addition may be applied to another system without a fixed uplinkidownlink configuration, or may be applied to a system having a fixed uplink/downlink configuration. For example, the technical solution provided in this embodiment of the present invention may also be applied to an FDD system, a TDD system, or the like. This is not limited in this embodiment of the present invention.

The technical solutions provided in the embodiments of the present invention are described below with reference to the accompanying drawings in the specification.

Referring to FIG. 2, an embodiment of the present invention provides a method for transmitting HARQ acknowledgement information applied to an application scenario. The application scenario shown in FIG. 1 is used as an example. In this embodiment of the present invention, that a network device is a base station is used as an example.

S201: When sending downlink data to user equipment in a subframe n, the base station may send first information to user equipment at the same time, where the first information is information used to indicate a subframe used by the user equipment to send HARQ acknowledgement information to the base station on an unlicensed carrier. The user equipment receives the first information sent by the base station.

In an implementation, the first information may be sent by using a physical downlink control channel. For example, the first information may be carried in downlink control information of the physical downlink control channel (where this is used as an example in the embodiment shown in FIG. 2), or the first information may be sent separately, or the first information may be carried in other information in the physical downlink control channel. This is not limited in this embodiment of the present invention.

The downlink control information is scheduling information sent by the base station to the user equipment, and the downlink control information is, for example, downlink control information (Downlink Control Information, DCI), or may be other information. For example, before sending the downlink data to the user equipment, the base station may first send DCI to the user equipment, and schedules a downlink transmission resource to the user equipment by using the DCI, so that the user equipment may receive, based on the downlink transmission resource indicated by the DCI, the downlink data sent by the base station. The downlink control information may carry uplinkidownlink transmission resource allocation information, HARQ information, power control information, or the like.

That the base station sends the downlink data to the user equipment is used as an example. Currently, the DCI sent by the base station to the user equipment usually includes a downlink transmission resource scheduled for the downlink data. In a system having a fixed uplinkdownlink configuration, a subframe in which the user equipment feeds back the HARQ acknowledgement information for the downlink data is usually specified by using a protocol. However, for a system without a fixed uplink/downlink configuration, for example, an LAA-LTE system, a subframe that is selected by the user equipment and in which the HARQ acknowledgement information is sent is probably not an uplink subframe, and this may lead to a failure of sending the HARQ acknowledgement information. Therefore, in this embodiment of the present invention, the base station may send the first information to the user equipment, the first information may indicate a subframe in which the user equipment sends the HARQ acknowledgement information, and the user equipment does not need to select a subframe on its own. In addition, uplink subframes are known to the base station, and therefore a possibility that a subframe selected by the user equipment is not an uplink subframe can be minimized, thereby improving a success rate of sending the HARQ acknowledgement information.

In an implementation, the first information may be used to indicate a single subframe. In this case, the first information may include a subframe index or a subframe index offset of the single subframe indicated by the first information. If the first information includes the subframe index offset of the indicated single subframe, the subframe index offset may be an offset of the subframe index of the subframe indicated by the first information relative to a subframe index of a subframe in which the network device sends downlink data to the user equipment, and the downlink data is downlink data corresponding to the HARQ acknowledgement information. The correspondence herein means that the HARQ acknowledgement information is used for feeding back whether the downlink data is successfully received by the user equipment. For example, the base station sends the DCI to the user equipment, and the DCI is used to schedule the downlink data sent by the base station to the user equipment in the subframe n. The first information is carried in the DCI. One or more bits (bit) are newly added to the DCI, and the newly-added bit is used as the first information to carry k or n+k to indicate the subframe n+k in which the user equipment sends the HARQ acknowledgement information to the base station for the downlink data. n+k is an index of the subframe in which the user equipment sends the HARQ acknowledgement information. If the first information includes k, the user equipment may calculate n+k on its own, and k may be considered as the subframe index offset. If the first information directly includes n+k, the user equipment does not need to perform calculation.

If the first information is used to indicate a single subframe, the subframe selected by the base station may be an uplink subframe at a shortest distance from n. For example, the base station sends downlink data in the subframe n, the subframe n, a subframe n+1, a subframe n+2, and a subframe n+3 are all downlink subframes, and a subframe n+4, a subframe n+5, a subframe n+6, and a subframe n+7 are all uplink subframes. Among the uplink subframes, the subframe n+4 is at a shortest distance from the subframe n, that is, a difference between n+4 and n is the smallest. Therefore, the base station may enable the first information to indicate the subframe n+4, so that a delay in feeding back the HARQ acknowledgement information may be reduced as much as possible. Certainly, a subframe indicated by the first information is not limited thereto. The base station may also select, based on another factor, a proper uplink subframe as the subframe indicated by the first information. For example, it may be required that a distance between a subframe in which a HARQ acknowledgement message is fed back and a subframe in which the base station sends the downlink data be greater than or equal to 4 ms, and therefore k in a selected uplink subframe n+k is greater than or equal to 4.

In an alternative solution of the first information indicating the single subframe, the first information may be used to indicate a plurality of subframes. This may also be considered as that the first information indicates a subframe window, and the subframe window includes the plurality of subframes indicated by the first information. In this embodiment of the present invention, the first information may include one or more of subframe indexes of the plurality of subframes in the subframe window indicated by the first information, a subframe index of a start subframe and a subframe index of an end subframe in the subframe window, and a subframe index of a start subframe in the subframe window and subframe span information. The subframe span information is used to indicate a quantity of the subframes indicated by the first information, that is, a subframe index of a subframe that is indicated by the first information and that is included in the subframe window may be obtained based on the subframe index of the start subframe in the subframe window and the subframe span information. If the first information includes subframe indexes of a plurality of subframes, the plurality of subframes may be consecutive subframes or non-consecutive subframes.

If the first information is used to indicate a subframe window, the start subframe selected by the base station in the subframe window may be an uplink subframe at a shortest distance from n. For example, the base station sends downlink data in the subframe n, the subframe n, a subframe n+1, a subframe n+2, and a subframe n+3 are all downlink subframes, and a subframe n+4, a subframe n+5, a subframe n+6, and a subframe n+7 are uplink subframes. Among the uplink subframes, the subframe n+4 is at a shortest distance from the subframe n, that is, a difference between n+4 and n is the smallest. Therefore, the base station may enable the start subframe in the subframe window indicated by the first information to be the subframe n+4. In addition, in the subframe window indicated by the first information, an excessively large span of the subframe may lead to inadequate time efficiency, and therefore the span of the subframe window indicated by the first information may be selected to be within a proper range, for example, to be less than or equal to 10 or to be less than or equal to 8. In this way, a delay in feeding back the HARQ acknowledgement information may be minimized. Certainly, a subframe indicated by the first information is not limited thereto. The base station may also select, based on another factor, a proper uplink subframe as the subframe indicated by the first information.

For example, the base station sends the DCI to the user equipment, and the DCI is used to schedule the downlink data sent by the base station to the user equipment in the subframe n. The first information is carried in the DCI. One or more bits (bit) are newly added to the DCI, and the newly-added bit is used to carry the first information indicating the subframe window, to indicate the uplink subframe that is included in the subframe window and in which the user equipment sends the HARQ acknowledgement information for the downlink data to the base station.

For example, the subframe window indicated by the first information is a subframe window whose start subframe is a subframe n+4 and whose end subframe is a subframe n+7, and the subframe window includes four uplink subframes, namely, the subframe n+4, a subframe n+5, a subframe n+6, and the subframe n+7. The first information may include subframe indexes, namely, n+4, n+5, n+6, and n+7, of the four subframes. Alternatively, the first information may include a subframe index of the start subframe and a subframe index of the end subframe in the subframe window, the subframe index of the start subframe is n+4, and the subframe index of the end subframe is n+7. Based on the subframe indexes, the user equipment may learn that the subframes indicated by the first information are the subframe n+4, the subframe n+5, the subframe n+6, and the subframe n+7. Alternatively, the first information may include a subframe index of the start subframe in the subframe window and subframe span information, the subframe index of the start subframe is n+4, and the subframe span information is 3. Based on the subframe index and the subframe span information, the user equipment may learn that the subframes indicated by the first information are the subframe n+4, the subframe n+5, the subframe n+6, and the subframe n+7. Certainly, the numbers herein are merely examples provided to describe the solution in this embodiment of the present invention, and this is not limited during actual application.

In addition, the foregoing example describes a case in which the subframe indexes of the subframes indicated by the first information are consecutive. During actual application, the subframe indexes indicated by the first information may alternatively be nonconsecutive. For example, the subframe n+4, the subframe n+5, the subframe n+6, and the subframe n+7 are all uplink subframes, and the first information may be used to indicate some of the uplink subframes. For example, the first information indicates the subframe n+4, the subframe n+6, and the subframe n+7 but does not indicate the subframe n+5, or indicates the subframe n+4 and the subframe n+7 but does not indicate the subframe n+5 and the subframe n+6. In this case, the subframe indexes indicated by the first subframe are nonconsecutive.

S202. The base station sends the downlink data to the user equipment, and the user equipment receives the downlink data.

In this embodiment of the present invention, that the first information is carried in DCI is used as an example. The DCI is used to schedule a downlink transmission resource. Therefore, after sending the DCI to the user equipment, the base station needs to send downlink data scheduled by using the DCI to the user equipment.

S203. The user equipment sends HARQ acknowledgement information for the downlink data sent by the base station, and the base station receives the HARQ acknowledgement information. If the user equipment determines that the downlink data is successfully received, the HARQ acknowledgement information sent by the user equipment is an ACK. If the user equipment determines that the downlink data fails to be received, the HARQ acknowledgement information sent by the user equipment is a NACK.

The user equipment determines, depending on whether the downlink data is successfully received, whether the HARQ acknowledgement information sent to the base station is an ACK or a NACK, and then sends the HARQ acknowledgement information to the base station on an unlicensed carrier in the subframe indicated by the first information.

In an implementation, if the first information includes a subframe index of a single subframe, the user equipment directly sends the HARQ acknowledgement information to the base station based on the subframe index included in the first information.

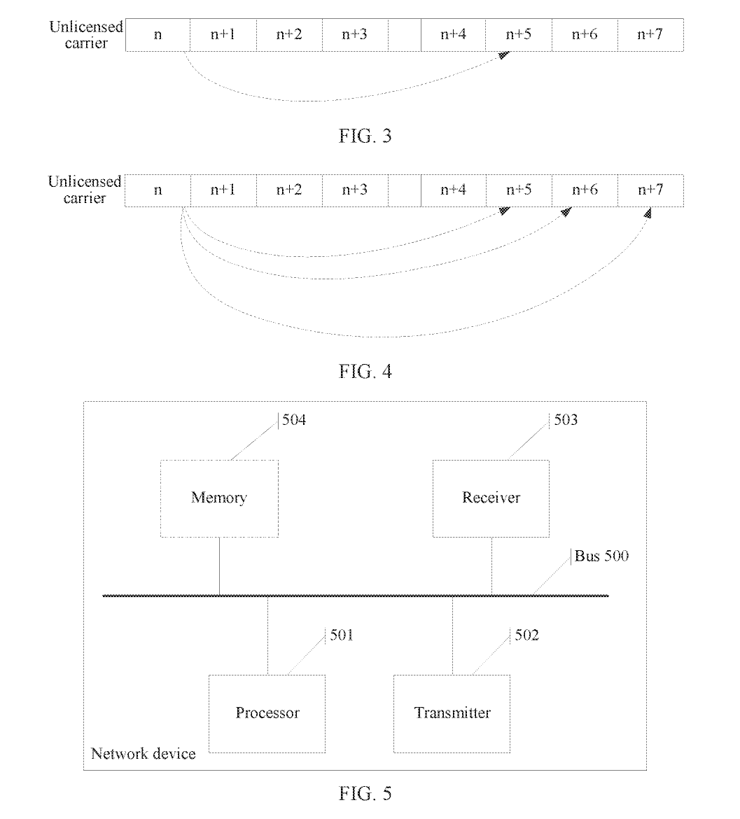

For example, referring to FIG. 3, the base station sends DCI to the user equipment on a PDCCH of the subframe n, the DCI includes the first information, and the first information indicates the subframe n+5, that is, k=5, that is on the unlicensed carrier and in which the user equipment sends the HARQ acknowledgement information for the downlink data to the base station. After receiving the DCI, the user equipment preempts, based on indication in the DCI, a channel in the subframe n+5 on the unlicensed carrier by using an LBT mechanism. If the channel is successfully preempted, the user equipment sends the HARQ acknowledgement information for the downlink data to the base station in the subframe n+5. In FIG. 3, for example, the subframe n, the subframe n+1, the subframe n+2, and the subframe n+3 are downlink subframes, and the subframe n+4, the subframe n+5, the subframe n+6, and the subframe n+7 are uplink subframes.

However, because the user equipment needs to preempt a channel first before sending data on an unlicensed carrier, the user equipment may fail to preempt a channel. The embodiment shown in FIG. 3 is still used as an example. If the user equipment fails to preempt a channel in the subframe n+5 on the unlicensed carrier, apparently, the user equipment cannot send the HARQ acknowledgement information to the base station by using the subframe indicated by the base station. In this case, to ensure that the HARQ acknowledgement information can be sent to the base station, the user equipment may send the corresponding HARQ acknowledgement information on another unlicensed carrier. Certainly, a premise for doing this is that there are a plurality of carriers, and certainly a channel needs to be preempted when the HARQ acknowledgement information is sent on each unlicensed carrier. If a channel on one of the unlicensed carriers is successfully preempted, the HARQ acknowledgement information is sent to the base station on the unlicensed carrier. There may be another case that the user equipment fails to preempt a channel on all unlicensed carriers of the user equipment. In this case, the user equipment may send the HARQ acknowledgement information to the base station on a licensed carrier. Alternatively, if the user equipment fails to preempt a channel in the subframe n+5 on an unlicensed carrier, that is, fails to preempt a channel on an unlicensed carrier indicated by the first information, the user equipment may directly send the HARQ acknowledgement information on the licensed carrier. A channel does not need to be preempted on the licensed carrier, and the HARQ acknowledgement information can be directly sent, so that efficiency is relatively high and a success rate of sending the HARQ acknowledgement information is improved.

If the user equipment fails to send the HARQ acknowledgement information in the subframe indicated by the first information, when the user equipment sends the HARQ acknowledgement information to the network device on the unlicensed carrier or the licensed carrier, the user equipment may first send a notification message to the network device. The notification message is used to instruct the user equipment to send the HARQ acknowledgement information to the network device on the unlicensed carrier, or is used to instruct the user equipment to send the HARQ acknowledgement information to the network device on the unlicensed carrier, so that the network device may listen and receive the HARQ acknowledgement information at a correct location. If the user equipment sends the HARQ acknowledgement information successfully after making attempts on several carriers to send the HARQ acknowledgement information, for example, making separate attempts to preempt a channel on a plurality of unlicensed carriers, each time the user equipment sends the HARQ acknowledgement information on another carrier, the user equipment needs to send a notification message to the network device.

Alternatively, in an alternative solution of sending the notification message to the network device by the user equipment, the network device is a recipient. If the network device does not receive, in the subframe indicated by the first information, the HARQ acknowledgement information sent by the user equipment, the network device determines that the user equipment fails to send the HARQ acknowledgement information, and the network device may send the notification message to the user equipment. The notification message is used to instruct the user equipment to send the HARQ acknowledgement information to the network device on an unlicensed carrier. In this case, the notification message may indicate a specific unlicensed carrier, or the notification message is used to instruct the user equipment to send the HARQ acknowledgement information to the network device on a licensed carrier. In this way, the user equipment may send the HARQ acknowledgement information on another carrier based on the indication of the network device, and the network device may correctly receive the HARQ acknowledgement information. If the network device sends a notification message to the user equipment once, where the notification message is used to instruct the user equipment to send the HARQ acknowledgement information to the network device on the unlicensed carrier, and the network device still does not receive the HARQ acknowledgement information on the indicated unlicensed carrier, the network device determines that the user equipment still sends a device, and the network device may continue to send the notification message to the user equipment, to instruct the user equipment to send the HARQ acknowledgement information on another unlicensed carrier or a licensed carrier again.

In another implementation, if the first information is used to indicate a subframe window, the user equipment may send the HARQ acknowledgement information to the base station in any subframe in the subframe window indicated by the first information.

For example, referring to FIG. 4, the base station sends DCI to the user equipment on a PDCCH of the subframe n, the DCI includes the first information, and the first information indicates the subframe n+5, the subframe n+6 or the subframe n+7 that is on the unlicensed carrier and in which the user equipment sends the HARQ acknowledgement information for the downlink data to the base station. After receiving the DCI, the user equipment may first preempt, based on the indication in the DCI, a channel in the subframe n+5 on the unlicensed carrier by using an LBT mechanism. If the channel is successfully preempted, the user equipment sends the HARQ acknowledgement information for the downlink data to the base station in the subframe n+5 on the unlicensed carrier, and no longer needs to consider sending the HARQ acknowledgement information for the downlink data to the base station in the subframe n+6 and the subframe n+7. If the user equipment fails to preempt a channel in the subframe n+5 on the unlicensed carrier, the user equipment may preempt a channel in the subframe n+6 on the unlicensed carrier by using the LBT mechanism. If the channel is successfully preempted, the user equipment sends the HARQ acknowledgement information for the downlink data to the base station in the subframe n+6 on the unlicensed carrier, and no longer needs to consider sending the HARQ acknowledgement information for the downlink data to the base station in the subframe n+7. If the user equipment also fails to preempt the channel in the subframe n+6 on the unlicensed carrier, the user equipment may preempt a channel in the subframe n+7 on the unlicensed carrier by using the LBT mechanism, and the rest may be deduced by analogy. In FIG. 4, for example, the subframe n, the subframe n+1, the subframe n+2, and the subframe n+3 are downlink subframes, and the subframe n+4, the subframe n+5, the subframe n+6, and the subframe n+7 are uplink subframes.

It can be learned that, because the user equipment needs to preempt a channel, the user equipment may probably fail to preempt a channel on all of the subframe n+5, the subframe n+6, and the subframe n+7, and as a result, the user equipment cannot send the HARQ acknowledgement information to the base station in a subframe indicated by the base station. In this case, to ensure that the HARQ acknowledgement information can be sent to the base station, if there are a plurality of carriers, the user equipment may send the corresponding HARQ acknowledgement information on another unlicensed carrier. If the user equipment fails to preempt a channel on all unlicensed carriers of the user equipment, the user equipment may send the HARQ acknowledgement information to the base station on a licensed carrier. Alternatively, if the user equipment fails to preempt a channel in all subframes indicated by the first information on the unlicensed carrier, the user equipment may directly send the HARQ acknowledgement information on the licensed carrier. A channel does not need to be preempted on the licensed carrier, and the HARQ acknowledgement information can be directly sent, so that efficiency is relatively high and a success rate of sending the HARQ acknowledgement information is improved.

Similarly, if the user equipment fails to send the HARQ acknowledgement information in the subframe indicated by the first information, when the user equipment sends the HARQ acknowledgement information to the network device on the unlicensed carrier or the licensed carrier, the user equipment may first send a notification message to the network device. The notification message is used to instruct the user equipment to send the HARQ acknowledgement information to the network device on the unlicensed carrier, or is used to instruct the user equipment to send the HARQ acknowledgement information to the network device on the unlicensed carrier, so that the network device may listen and receive the HARQ acknowledgement information at a correct location.

Alternatively, in an alternative solution of sending the notification message to the network device by the user equipment, the network device is a recipient. If the network device does not receive, in the subframe indicated by the first information, the HARQ acknowledgement information sent by the user equipment, the network device determines that the user equipment fails to send the HARQ acknowledgement information, and the network device may send the notification message to the user equipment. The notification message is used to instruct the user equipment to send the HARQ acknowledgement information to the network device on an unlicensed carrier. In this case, the notification message may indicate a specific unlicensed carrier, or the notification message is used to instruct the user equipment to send the HARQ acknowledgement information to the network device on a licensed carrier. In this way, the user equipment may send the HARQ acknowledgement information on another carrier based on the indication of the network device, and the network device may correctly receive the HARQ acknowledgement information. For descriptions of sending a notification message by the user equipment to the network device or sending a notification message by the network device to the user equipment, refer to related descriptions in the part in which the first information includes the subframe index of the single subframe. Details are not described herein again.

For the user equipment, because the licensed carrier needs to transmit a relatively large amount of information, a resource on the licensed carrier is relatively valuable. Therefore, in this embodiment of the present invention, the HARQ acknowledgement information is preferentially sent on an unlicensed carrier. Certainly, if the HARQ acknowledgement information is not successfully sent on the unlicensed carrier, the HARQ acknowledgement information may be sent on the licensed carrier instead, to ensure a high success rate of sending the HARQ acknowledgement information.

A device provided in an embodiment of the present invention is described in the following with reference to the accompanying drawings.

Referring to FIG. 5, an embodiment of the present invention provides a first network device. The network device may include a processor 501, a transmitter 502, and a receiver 503.

The processor 501 may include a central processing unit (CPU) or an application-specific integrated circuit (Application-Specific Integrated Circuit, ASIC), may include one or more integrated circuits for controlling execution of programs, may include a hardware circuit developed by using a field programmable gate array (Field Programmable Gate Array, FPGA), and may include a baseband chip.

The transmitter 502 may be configured to perform network communication with an external device, for example, may perform communication with an external device by using a network such as an Ethernet network, a radio access network, a wireless local area network, or a wired network.

The receiver 503 may be configured to perform network communication with an external device, for example, may perform communication with an external device by using a network such as an Ethernet network, a radio access network, a wireless local area network, or a wired network.

Optionally, the receiver 503 and the transmitter 502 may be one functional module, for example, a functional module that can implement both a sending function and a receiving function. Alternatively, the receiver 503 and the transmitter 502 may be different submodules in a functional module. Alternatively, the receiver 503 and the transmitter 502 may be two independent functional modules.

Optionally, the network device may further include a memory 504. There may be one or more memories 504. The memory 504 may include a read only memory (Read Only Memory, ROM), a random access memory (Random Access Memory, RAM), a magnetic disk memory, and the like. The memory 504 may be configured to store program code required by the processor 501 for executing a task, may further be configured to store data, and the like. Being an optional functional module instead of an indispensable functional module, the memory 504 is shown by using dashed lines in FIG. 5.

The memory 504, the receiver 503, and the transmitter 502 may be connected to the processor 501 by using a bus 500) (where this is used as an example in FIG. 5), or may be connected to the processor 501 by using a dedicated connection wire.

The processor 501 is designed and programmed, so that code corresponding to the method shown in the foregoing is built into a chip, enabling the chip to perform, when running, the method shown in the foregoing embodiments. How to design and program the processor 501 is a technology well known to persons skilled in the art. Details are no longer described again herein.

The network device may be configured to perform the method provided in the embodiment shown in FIG. 2, and may be, for example, the foregoing network device. Therefore, for functions and the like implemented by the units in the network device, refer to the description of the foregoing method part, and details are not described.

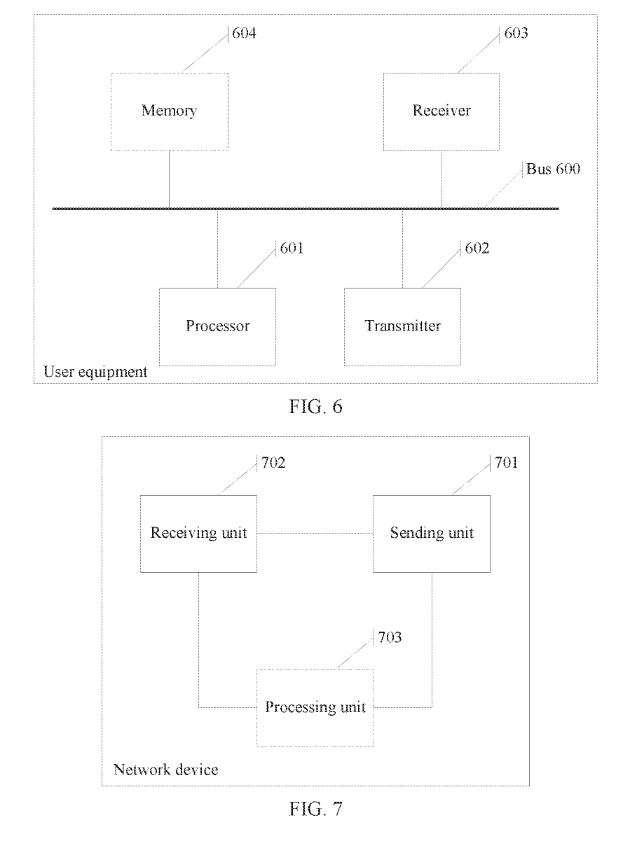

Referring to FIG. 6, an embodiment of the present invention provides first user equipment. The user equipment may include a processor 601, a transmitter 602, and a receiver 603.

The processor 601 may include a CPU or an ASIC, may include one or more integrated circuits for controlling execution of programs, may include a hardware circuit developed by using an FPGA, and may include a baseband chip.

The transmitter 602 may be configured to perform network communication with an external device, for example, may perform communication with an external device by using a network such as an Ethernet network, a radio access network, a wireless local area network, or a wired network.

The receiver 603 may be configured to perform network communication with an external device, for example, may perform communication with an external device by using a network such as an Ethernet network, a radio access network, a wireless local area network, or a wired network.

Optionally, the receiver 603 and the transmitter 602 may be one functional module, for example, a functional module that can implement both a sending function and a receiving function. Alternatively, the receiver 603 and the transmitter 602 may be different submodules in a functional module. Alternatively, the receiver 603 and the transmitter 602 may be two independent functional modules.

Optionally, the user equipment may further include a memory 604. There may be one or more memories 604. The memory 604 may include a ROM, a RAM, a magnetic disk memory, and the like. The memory 604 may be configured to store program code required by the processor 601 for executing a task, may further be configured to store data, and the like. Being an optional functional module instead of an indispensable functional module, the memory 604 is shown by using dashed lines in FIG. 6.

The memory 604, the receiver 603, and the transmitter 602 may be connected to the processor 601 by using a bus 600 (where this is used as an example in FIG. 6), or may be connected to the processor 601 by using a dedicated connection wire.

The processor 601 is designed and programmed, so that code corresponding to the method shown in the foregoing is built into a chip, enabling the chip to perform, when running, the method shown in the foregoing embodiments. How to design and program the processor 601 is a technology well known to persons skilled in the art. Details are no longer described again herein.

The user equipment may be configured to perform the method provided in the embodiment shown in FIG. 2, and may be, for example, the foregoing user equipment. Therefore, for functions and the like implemented by the units in the user equipment, refer to the description of the foregoing method part, and details are not described.

Referring to FIG. 7, an embodiment of the present invention provides a second network device. The network device may include a sending unit 701 and a receiving unit 702.

Optionally, the network device may further include a processing unit 703 that is also shown in FIG. 7. Being an optional functional module, the processing unit 703 is shown in FIG. 7 by using dashed lines.

During actual application, a physical device corresponding to the sending unit 701 may be the transmitter 502 in the embodiment shown in FIG. 5, a physical device corresponding to the receiving unit 702 may be the receiver 503 in the embodiment shown in FIG. 5, and a physical device corresponding to the processing unit 703 may be the processor 501 in the embodiment shown in FIG. 5.

The network device may be configured to perform the method provided in the embodiment shown in FIG. 2, and may be, for example, the foregoing network device. Therefore, for functions and the like implemented by the units in the network device, refer to the description of the foregoing method part, and details are not described.

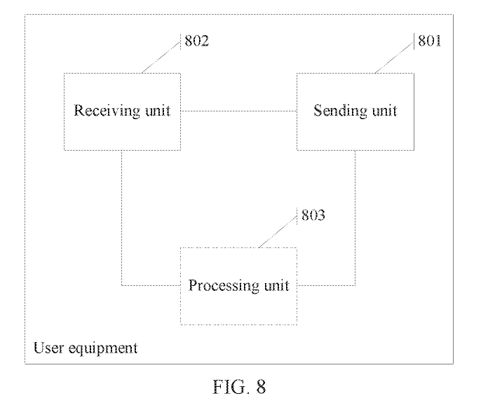

Referring to FIG. 8, an embodiment of the present invention provides second user equipment. The user equipment may include a sending unit 801 and a receiving unit 802.

Optionally, the user equipment may further include a processing unit 803 that is also shown in FIG. 8. Being an optional functional module, the processing unit 803 is shown in FIG. 8 by using dashed lines.

During actual application, a physical device corresponding to the sending unit 801 may be the transmitter 602 in the embodiment shown in FIG. 6, a physical device corresponding to the receiving unit 802 may be the receiver 603 in the embodiment shown in FIG. 6, and a physical device corresponding to the processing unit 803 may be the processor 601 in the embodiment shown in FIG. 6.

The user equipment may be configured to perform the method provided in the embodiment shown in FIG. 2, and may be, for example, the foregoing user equipment. Therefore, for functions and the like implemented by the units in the user equipment, refer to the description of the foregoing method part, and details are not described.

In the embodiments of the present invention, an uplink subframe is known to the network device, and therefore the network device may send the first information to the user equipment. The first information indicates a subframe that can be used by the user equipment to send the HARQ acknowledgement information to the network device. After receiving the first information, the user equipment may send the HARQ acknowledgement information to the network device based on the first information, that is, perform HARQ feedback. To be specific, the embodiments of the present invention provide a manner of performing HARQ feedback, by using which the HARQ feedback can be desirably performed. In addition, the subframe indicated by the network device is the uplink subframe, so that a case is avoided that the user equipment selects a subframe on its own and therefore may fail to select a subframe.

In the present invention, it should be understood that the disclosed device and method may be implemented in other manners. For example, the described apparatus embodiment is merely an example. For example, the unit division is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic or other forms.

The units described as separate parts may or may not be physically separate, and parts displayed as units may or may not be physical units, may be located in one position, or may be distributed on a plurality of network units. Some or all of the units may be selected according to actual needs to achieve the embodiments of the present invention.

Functional units in the embodiments of the present invention may be integrated into one processing unit, or each of the units may be an independent physical module.

When the integrated unit is implemented in the form of a software functional unit and sold or used as an independent product, the integrated unit may be stored in a computer-readable storage medium. Based on such an understanding, all of or a part of the technical solutions of the present invention may be implemented in a form of a software product. The computer software product is stored in a storage medium and includes several instructions for instructing a computer device, for example, a personal computer, a server, or a network device or a processor (processor) to perform all or some of the steps of the methods described in the embodiments of the present invention. The foregoing storage medium includes: any medium that can store program code, such as a Universal Serial Bus flash drive (Universal Serial Bus flash drive), a removable hard disk, a read-only memory (Read-Only Memory, ROM), a random access memory (random access memory, RAM), a magnetic disk, or an optical disc.

The foregoing embodiments are merely used to describe the technical solutions of the present invention. The foregoing embodiments are merely intended to help understand the method of the present invention, and shall not be construed as a limitation on the embodiments of the present invention. Any variation or replacement readily figured out by persons skilled in the art shall fall within the protection scope of the embodiments of the present invention.

1. A method for transmitting hybrid automatic repeat request (HARQ) acknowledgement information, comprising:
sending, by a network device, first information to user equipment, wherein the first information indicates a subframe to be used by the user equipment to send the HARQ acknowledgement information to the network device on an unlicensed carrier; and
receiving, by the network device in the subframe indicated by the first information, the HARQ acknowledgement information from the user equipment.

2. The method of claim 1, wherein the first information indicates a single subframe, and wherein the first information comprises a subframe index of the single subframe.

3. The method of claim 1, wherein the first information indicates a subframe window, and wherein the first information comprises subframe indexes of a plurality of subframes in the subframe window indicated by the network device.

4. The method of claim 3, wherein the subframes are consecutive subframes.

5. The method of claim 1, wherein the first information is carried in downlink control information of a physical downlink control channel.

6. The method of claim 1, where after receiving the HARQ acknowledgement information from the user equipment, the method further comprises:
failing, by the network device, to receive the HARQ acknowledgement information in the subframe indicated by the first information; and
receiving, by the network device, a notification message from the user equipment, wherein the notification message instructs the network device to receive the HARQ acknowledgement information on another unlicensed carrier or on a licensed carrier.

7. A method for transmitting hybrid automatic repeat request (HARQ) acknowledgement information, comprising:
receiving, by user equipment, first information from a network device, wherein the first information indicates a subframe to be used by the user equipment to send the HARQ acknowledgement information to the network device on an unlicensed carrier; and
sending, by the user equipment, the HARQ acknowledgement information to the network device in the subframe indicated by the first information.

8. The method of claim 7, wherein the first information indicates a single subframe, and wherein the first information comprises a subframe index of the single subframe.

9. The method of claim 7, wherein the first information indicates a subframe window, and wherein the first information comprises at least one of:
subframe indexes of a plurality of subframes in the subframe window indicated by the network device;
a subframe index of a start subframe and a subframe index of an end subframe in the subframe window; or
the subframe index of the start subframe in the subframe window and subframe span information, wherein the subframe span information indicates a quantity of the subframes indicated by the first information.

10. The method of claim 9, wherein the first information comprises the subframe indexes of the subframes, and wherein the subframes are consecutive subframes or non-consecutive subframes.

11. The method of claim 7, wherein the first information is carried in downlink control information of a physical downlink control channel.

12. The method of claim 7, wherein after receiving the first information from the network device, the method further comprises preempting, by the user equipment, a channel on the unlicensed carrier, and wherein sending the HARQ acknowledgement information to the network device in the subframe indicated by the first information comprises sending, by the user equipment, the HARQ acknowledgement information to the network device in the subframe indicated by the first information when the user equipment successfully preempts the channel on the unlicensed carrier.

13. The method of claim 12, further comprising:
failing, but the user equipment, to preempt the channel on the unlicensed carrier; and
sending, by the user equipment, the HARQ acknowledgement information to the network device on another unlicensed carrier.

14.-26. (canceled)

27. The method of claim 1, wherein after receiving the HARQ acknowledgement information from the user equipment, the method further comprises:
failing, by the network device, to receive the HARQ acknowledgement information in the subframe indicated by the first information; and
sending, by the network device, a notification message to the user equipment, wherein the notification message instructs the user equipment to send the HARQ acknowledgement information on another unlicensed carrier or on a licensed carrier.

28. The method of claim 12, further comprising:
failing, by the user equipment, to preempt the channel on the unlicensed carrier; and
sending, by the user equipment, the HARQ acknowledgement information to the network device on a licensed carrier.

29. The method of claim 1, wherein the first information indicates a single subframe, wherein the first information comprises a subframe index offset of the single subframe, wherein the subframe index offset indicates an offset of a subframe index of the single subframe relative to a subframe index of a subframe in which the network device sends downlink data to the user equipment, and wherein the downlink data corresponds to the HARQ acknowledgement information.

30. The method of claim 1, wherein the first information indicates a subframe window, and wherein the first information comprises a subframe index of a start subframe and a subframe index of an end subframe in the subframe window.

31. The method of claim 1, wherein the first information indicates a subframe window, wherein the first information comprises a subframe index of a start subframe in the subframe window and subframe span information, and wherein the subframe span information indicates a quantity of subframes indicated by the first information.

32. The method of claim 3, wherein the subframes are non-consecutive subframes.

33. The method of claim 7, wherein the first information indicates a single subframe, wherein the first information comprises a subframe index offset of the single subframe, wherein the subframe index offset indicates an offset of a subframe index of the single subframe relative to a subframe index of a subframe in which the network device sends downlink data to the user equipment, and wherein the downlink data corresponds to the HARQ acknowledgement information.
